(19) United States
(12) Patent Application Publication
(10) Pub. No.: US 2026/0249935 A1
(43) Pub. Date: Aug. 27, 2026

(54) ENDLESS TRACK FOR A TRACK SYSTEM

(71) Applicant: SOUCY INTERNATIONAL INC., Drummondville (CA)

(72) Inventors: Eric HALSTEAD, Sainte-Marie-Madeleine (CA); Jean-Stephane MBOUWE-BUECHI, Saint-Leonard-d'Aston (CA)

(21) Appl. No.: 19/161,758

(22) PCT Filed: Mar. 8, 2024
(86) PCT No.: PCT/CA2024/050291

§ 371 Date: Sep. 3, 2025

Related U.S. Application Data
(60) Provisional application No. 63/451,149, filed on Mar. 9, 2023.
(60) Provisional application No. 63/469,640, filed on May 30, 2023.

(51) Int. Cl. B62D 55/26; B62D 55/24

(52) U.S. Cl. CPC B62D 55/26; B62D 55/244

(57) ABSTRACT

An endless track, which is for a track system, includes a track body, a plurality of track engagers, and a plurality of traction lugs. The track body has an inner surface engageable by at least one wheel assembly, and an outer surface engageable to a ground surface. The plurality of track engagers are disposed on the inner surface, and are spaced along a length of the track body. The plurality of traction lugs project from the outer surface, are spaced along a length of the track body. A given traction lug has inner and outer portions. The inner and outer portions extend along a length of the given traction lag, and the outer portion is closer to an edge of the track body than the inner portion. The inner portion has an inner volume, and the outer portion has an outer volume smaller than the inner volume.

### CROSS-REFERENCE TO RELATED APPLICATION

The present application claims priority to U.S. Provisional Patent Application No. 63/451,149, filed Mar. 9, 2023 and to U.S. Provisional Patent Application No. 63/469,640, filed May 30, 2023, both of which are incorporated by reference herein in their entirety.

### TECHNICAL FIELD

The present application generally relates to endless tracks for track systems. More specifically, the present application relates to tread patterns for endless tracks that are optimized for low heat generation.

### BACKGROUND

Certain vehicles, such as, for example, agricultural vehicles (e.g., harvesters, combines, tractors, etc.), construction vehicles (e.g., trucks, front-end loaders, etc.) and recreational vehicles (e.g., all-terrain vehicles, utility-terrain vehicles, side-by-side vehicles, etc.) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle. For example, when the vehicle is an agricultural vehicle, the tires may compact the soil in such a way as to undesirably inhibit the growth of crops. When the vehicle is a recreational vehicle, the tires may lack traction on certain terrain and in certain conditions.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable agricultural vehicles to be used in wet field conditions as opposed to its wheeled counterpart. In other conditions, track systems enable recreational vehicles to be used in low traction terrains such as snowy roads.

Conventional track systems do, however, present some inconveniences. Some conventional track systems cannot compensate for uneven roads, such as, for example, crowned roads. As a result, endless tracks of these conventional track systems are subjected to uneven load distribution, which can lead to high stresses and high heat generation within the endless track, both causing premature wear of the endless track of the track system.

U.S. Pat. No. 10,875,591, incorporated herewith by reference, discloses a track system that is configured to perform better when the vehicle is roading. To this end, the track system is provided with track engaging wheels that are moveable relative to one another. Additionally, modifying the endless track by increasing the entire ground-contacting area of the traction lugs of the endless track is also disclosed.

Therefore, there is a desire for an endless track that could mitigate the above-mentioned issues.

### SUMMARY

It is an object of the present technology to ameliorate at least some of the inconveniences present in the prior art.

According to one aspect of the present technology, there is provided an endless track for a track system. The endless track includes a track body, a plurality of track engagers, and a plurality of traction lugs. The track body has an inner surface engageable by at least one wheel assembly of the track system, and an outer surface engageable to a ground surface. The plurality of track engagers are disposed on the inner surface, and are spaced along a length of the track body. The plurality of traction lugs project from the outer surface, and are spaced along a length of the track body. A given traction lug has an inner portion and an outer portion. The inner and outer portions extend along a length of the given traction lug. The outer portion is closer to an edge of the track body than the inner portion. The inner portion has an inner volume, and the outer portion has an outer volume, the outer volume being less than the inner volume.

In some embodiments, for the given traction lug, the inner portion extends in a first orientation, the outer portion extends in a second orientation, and the first orientation is different from the second orientation.

In some embodiments, the track body has a longitudinal plane, and the given traction lug is at least substantially perpendicular to the longitudinal plane.

In some embodiments, the outer portion of the given traction lug is at least partially perpendicular to the longitudinal plane.

In some embodiments, the given traction lug is partially arcuate.

In some embodiments, the endless track defines a plurality of recesses on the outer surface, a given recess of the plurality of recesses being in part defined by two adjacent traction lugs of the plurality of traction lugs.

In some embodiments, the given recess of the plurality of recesses has a funnel shape.

In some embodiments, for a given section of the endless track the plurality of traction lugs defines a traction lug contact area, the plurality of recesses defines a recessed area, and a ratio of the traction lug contact area over the recessed area is between 0.5 and 0.7.

In some embodiments, the ratio of the traction lug contact area over the recessed area is between 0.6 and 0.7.

In some embodiments, the ratio of the traction lug contact area over the recessed area is about 0.6 and 0.65.

In some embodiments, the ratio of the traction lug contact area over the recessed area is about 0.646.

In some embodiments, a given traction lug of the plurality of traction lugs has a first cross-sectional area taken across a plane perpendicular to the inner portion, and a second cross-sectional area taken across a plane perpendicular to the outer portion. The first cross-sectional area is greater than the second cross-sectional area.

In some embodiments, the first cross-sectional area has a first width, and the second cross-sectional area has a second width. The first width is greater than the second width.

In some embodiments, the first cross-sectional area has a first height, and the second cross-sectional area has a second height The first height is greater than the second height.

In some embodiments, the inner portion of the given traction lug includes an innermost section and an intermediate section being configured to extend below a wheel of the at least one wheel assembly.

In some embodiments, the given traction lug defines a notch at the innermost part.

In some embodiments, the plurality of track engagers is generally centered across a width of the track body.

In some embodiments, the plurality of track engagers is a plurality of driving lugs:

In some embodiments, the endless track is configured to reduce heat generation on the plurality of traction lugs in response to the endless track being operated on a crowned ground surface.

In some embodiments, the plurality of traction lugs is a first plurality of traction lugs disposed on a first lateral side of the track body, and the endless track further includes a second plurality of traction lugs disposed on a second lateral side of the track body.

In some embodiments, the outer portion of a traction lug of the first plurality of traction lugs is longitudinally offset from the outer portion of a corresponding traction lug of the second plurality of traction lugs.

In some embodiments, the track body has a first wheel path disposed on the first lateral side of the track body and a second wheel path disposed on the second lateral side of the track body, the outer portion of the traction lugs of the first plurality of traction lugs is laterally offset from the first wheel path, and the outer portion of the traction lugs of the second plurality of traction lugs is laterally offset from the second wheel path.

In some embodiments, the inner portions of the first and second plurality of traction lugs are closer to a center of width of the track body.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where.

FIG. 1 is a right side elevation view of a harvester having track systems with endless tracks according to embodiments of the present technology;

FIG. 2 is a schematic perspective view taken from a top, rear, right side of one of the track systems of FIG. 1;

FIG. 3 is a perspective view of a section of the endless track of FIG. 1, with an outer surface of the endless track being shown;

FIG. 4 is a top plan view of an inner surface of the section of the endless track of FIG. 3;

FIG. 5 is a top plan view of the outer surface of the section of the endless track of FIG. 3;

FIG. 6A is a cross-section of the section of the endless track of FIG. 3 taken across line 6A-6A of FIG. 5;

FIG. 6B is a cross-section of the section of the endless track of FIG. 3 taken across line 6B-6B of FIG. 5;

FIG. 7 is a perspective view of a section of an endless track according to an alternative embodiment of the present technology, and

FIG. 8 is a schematic view of the harvester of FIG. 1 travelling on a crowned road,

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology generally refers to various embodiments of endless tracks which are configured to reduce heat generation and more specifically, to various embodiments of endless tracks which are configured to reduce heat generation at their lateral edges when used on uneven roads, such as crowned roads. The endless tracks of the present technology will be described with reference to a harvester 40 and track systems 50.

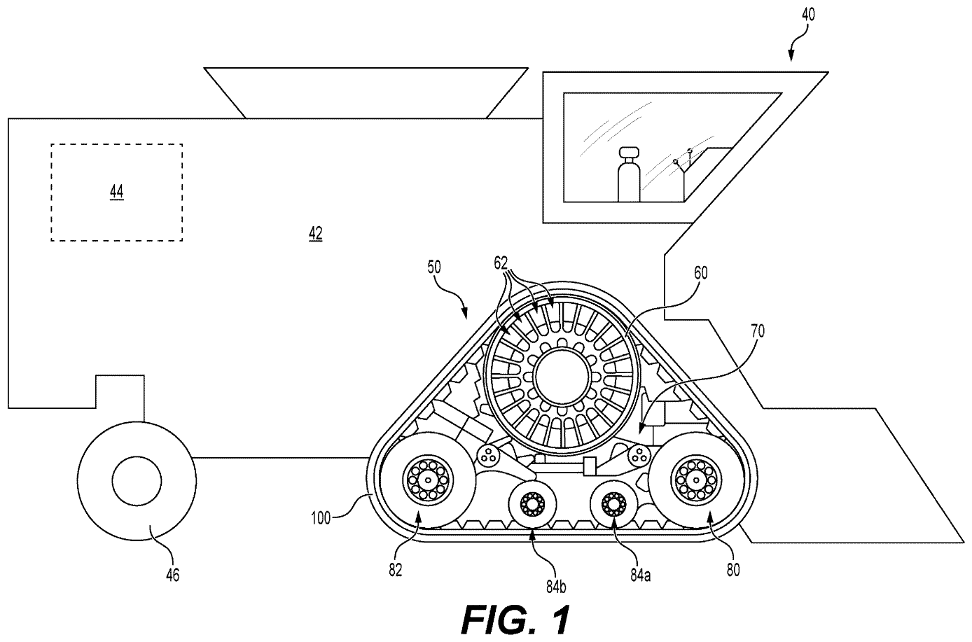

Referring to FIG. 1, the harvester 40 is shown. The harvester 40 has a frame 42 that houses an engine 44 (shown schematically). The harvester 40 also has left and right rear wheels 46 and the left and right track systems 50 (only right rear wheel 46 and right track system 50 are shown in the FIG. 1). It is contemplated that in some embodiments, the harvester 40 could have more than two track systems. The engine 44 is operatively connected to left and right track systems 50. It is contemplated that in some embodiments, the engine 44 could also be operatively connected to the rear wheels 46. It is understood that the present technology could be used with other vehicles such as bulldozers, skid-steer loaders, excavators and/or compact track loaders. Additionally, the present technology could also be used with other vehicles such as all-terrain-vehicles, snowmobiles, side-by-side vehicles or utility-terrain vehicles. It is further contemplated that the present technology could be used with industrial and military vehicles. It is also contemplated that the present technology could be used with trailers or other unpowered vehicles.

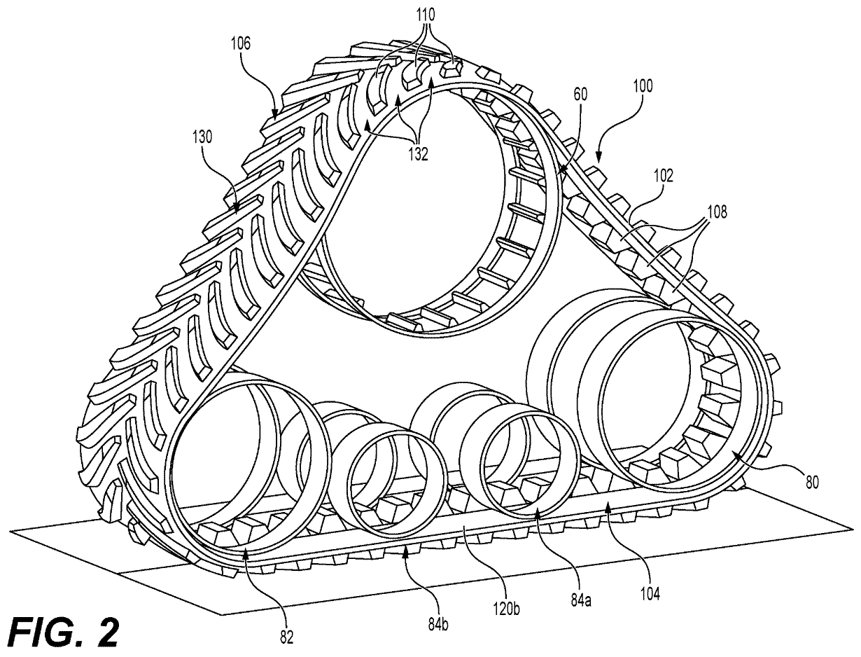

Referring to FIGS. 1 and 2, a non-limiting description of the track system 50 and various components thereof will now be provided. It is understood that some features of the track system 50 described herein may be absent in other implementations of the present technology and/or that track system 50 could have additional features not described herewith.

The track system 50 has a drive wheel assembly 60 that is operatively connected to an axle (not shown) of the harvester 40, such that when the axle rotates, the drive wheel assembly 60 also rotates, thereby driving the track system 50. The drive wheel assembly 60 may sometimes be referred to as a sprocket wheel assembly. The drive wheel assembly 60 defines a plurality of recesses 62. The plurality of recesses 62 are defined circumferentially on a periphery of the drive wheel assembly 60. The recesses 62 are configured to, as will be described in greater detail below, engage with lugs 108 provided on an inner surface 104 of an endless track 100.

The track system also has a frame 70 (shown on FIG. 1) that is rotationally connected to the drive wheel assembly 60. The frame 70 is disposed laterally inwardly from the drive wheel assembly 60. It is contemplated that in other embodiments, the frame 70 could be disposed laterally outwardly from the sprocket wheel assembly 60.

In the present embodiment, the frame 70 has upper and lower portions that do not move relative to one another (e.g., upper and lower portions are integral) Thus, in one implementation of the present technology, the upper portion and the lower portion of the frame 70 are not configured to pivot relative to each other. In some other embodiments, the upper and lower portions of the frame 70 could be moveable relative to one another. For example, the upper and lower portions could be pivotable relative to each other about a longitudinally extending axis and/or a laterally extending axis.

The track system 50 includes wheel assemblies that are rotationally connected to the frame 70 More precisely, the track system 50 includes the drive wheel assembly 60, a front idler wheel assembly 80, a rear idler wheel assembly 82 and two support wheel assemblies 84a, 84b which are disposed longitudinally between the front and rear idler wheel assemblies 80, 82. It is contemplated that in some embodiments, the track system 50 could have more or fewer than two support wheel assemblies.

Each one of the front and rear idler wheel assemblies 80, 82, and the support wheel assemblies 84a, 84b has two laterally spaced wheels, such that each one of the front and rear idler wheel assemblies 80, 82, and the support wheel assemblies 84a, 84b has left and right wheels.

In the present embodiment, the track system 50 is configured such that the front and rear idler wheel assemblies 80, 82 and the support wheel assemblies 84a, 84b are not configured to pivot relative to the frame 70. In other embodiments, one or more of the front and rear idler wheel assemblies 80, 82 and the support wheel assemblies 84a, 84b could be configured to pivot relative to the frame 70 about a longitudinally extending axis and/or a laterally extending axis.

It is contemplated that in some embodiments, the track system 50 could include a tensioner that is configured to adjust tension in the endless track 100.

The track system 50 also includes the endless track 100, which will now be described in greater detail with reference to FIGS. 2 to 5. The endless track 100 extends around components of the track system 50, such that the endless track 100 surrounds the drive wheel assembly 60, the frame 70 and the idler and support wheel assemblies 80, 82, 84a, 84b.

The endless track 100, which is an elastomeric endless track, has a track body 102 having an inner surface 104 facing the wheel assemblies and an outer surface 106 for contacting the ground, a plurality of track engagers 108 disposed on the inner surface 104, and a plurality of traction lugs 110 projecting from the outer surface 106.

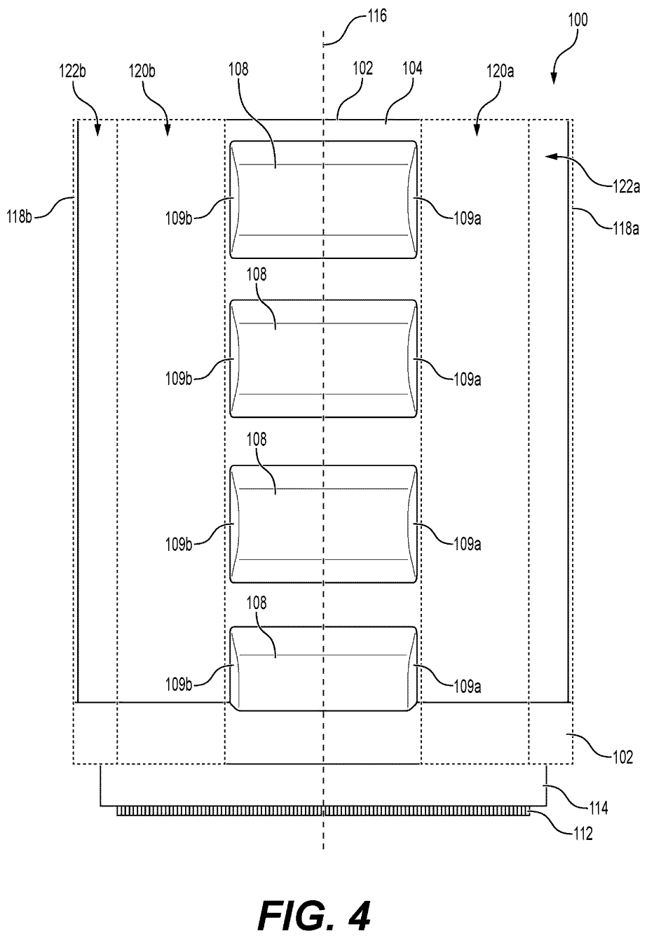

As shown on FIG. 4, embedded in the track body 102, between the inner and outer surfaces 104, 106, the endless track 100 has longitudinally extending reinforcing cables 112 and reinforcing sheets 114. The reinforcing cables and sheets 112, 114 are configured to generally limit longitudinal elongation of the track body 102 and/or limit the longitudinal deformation. Thus, the reinforcing cables and sheets 112, 114 reinforce the endless track 100, which can assist in reducing the likelihood of the endless track 100 from being torn and/or damaged. In some instances, the reinforcing cables and sheets 112, 114 can prolong life of the endless track 100. It is contemplated that in some embodiments, the reinforcing cables 112 and/or the reinforcing sheets 114 could be omitted. The track body 102 is made of an elastomeric material. It is contemplated that the elastomeric material could be a polymeric material.

Still referring to FIG. 4, the plurality of track engagers 108, which are disposed on the inner surface 104, are configured to engage with the drive wheel assembly 60 for driving the endless track 100, and thus for driving the track system 50. In the illustrated embodiment, there is a single set of longitudinally spaced track engagers 108 that is disposed generally centrally across a width of the inner surface 104. Thus, a center of the track engagers 108 is aligned with a longitudinal center plane 116 of the track body 102. In this embodiment, the track engagers 108 are driving lugs 108 that project from the inner surface 104. It is contemplated that in other embodiments, the track engagers 108 could be recesses or apertures configured to receive teeth of the drive wheel assembly 60 therein. It is contemplated that in other embodiments, there could be two or more laterally spaced sets of longitudinally spaced track engagers 108.

On the left and right sides of the track engagers 108, the inner surface 104 has, respectively, wheel engaging sections 120a, 120b which are configured to engage with respectively, left and right wheels of the idler and support wheel assemblies 80, 82, 84a, 84b (e.g., the left wheels roll on the wheel engaging section 120a and the right wheel roll on the wheel engaging section 120b). The wheel engaging sections 120a, 120b extend longitudinally along a length of the endless track 100. The wheel engaging section 120a extends, in the lateral direction, from lateral lug edges 109a of the track engagers 108 toward a lateral track body edge 118a of the track body 102. Likewise, the wheel engaging section 120b extends, in the lateral direction, from lateral lug edges 109b of the track engagers 108 toward a lateral track body edge 118b of the track body 102. The wheel engaging sections 120a, 120b are generally flat.

The inner surface 104 also has external sections 122a, 122b disposed laterally outwardly from respective wheel engaging sections 122a, 122b, and that extend longitudinally along the length of the endless track 100. The external section 122a extends, in the lateral direction, from the wheel engaging section 120a toward the lateral track body edge 118a. Likewise, the external section 122b extends, in the lateral direction, from the wheel engaging section 120b toward the lateral track body edge 118b. The external sections 122a, 122b, could be sloped in some embodiments, such that laterally inner points of the external sections 122a, 122b could be vertically higher than laterally outer points of the external sections 122a, 122b. This could, inter alia, assist in reducing material required to manufacture the endless track 100, which could in turn assist in reducing rolling resistance induced by the endless track 100.

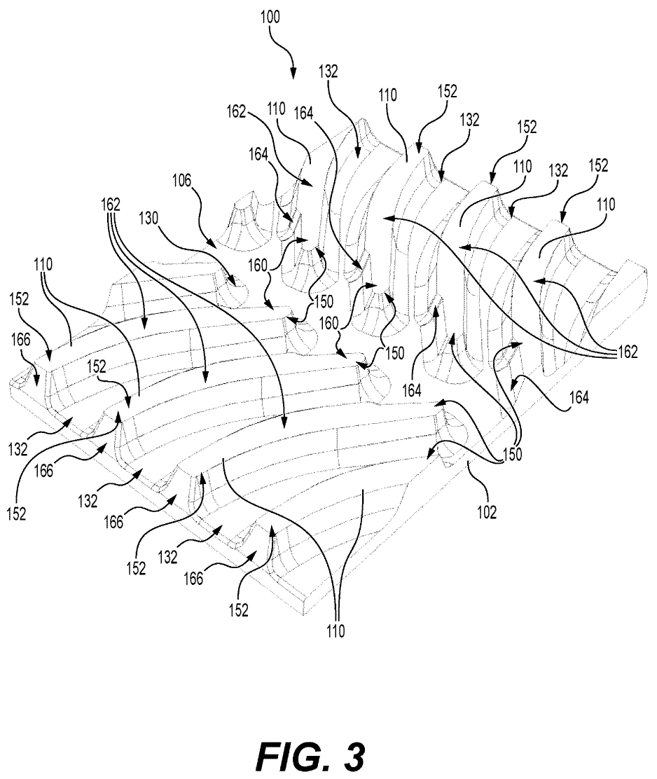

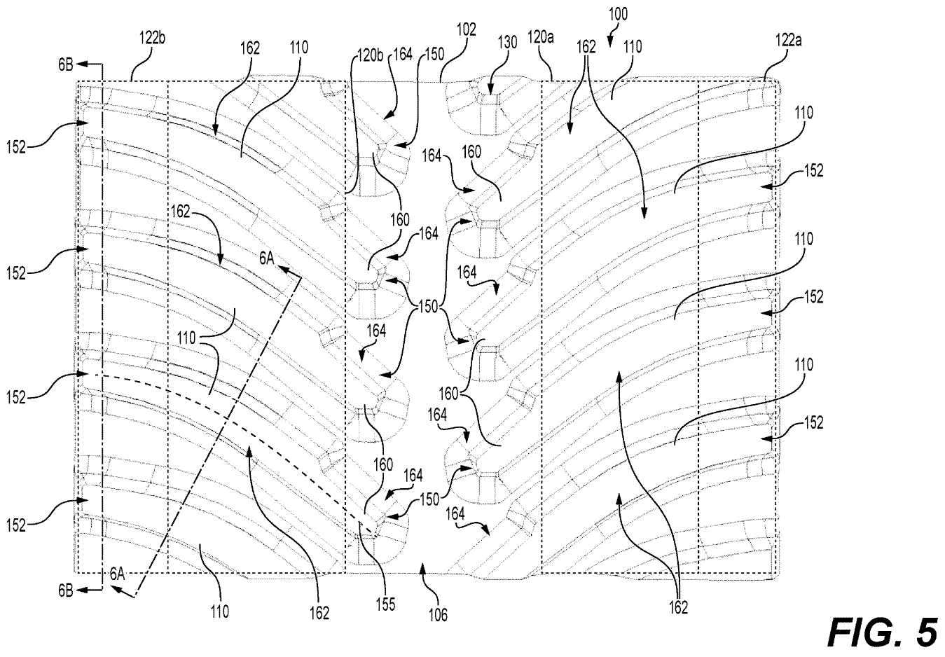

Referring to FIGS. 3 and 5, the outer surface 106 of the endless track 100 has, projecting therefrom, the plurality of traction lugs 110 that form an outer tread 130 Specifically, the outer tread 130 has two laterally spaced sets of longitudinally spaced tractions lugs 110. The traction lugs 110 of the left set are longitudinally offset from corresponding traction lugs 110 of the right set. It is contemplated that in other embodiments, the tractions lugs 110 of the left and right sets could be longitudinally aligned with one another. As will be described in greater detail here below, a plurality of recesses 132 are also defined on the outer surface 106, each recess 132 being at least partially defined by two adjacent traction lugs 110.

The traction lugs 110 of the left set are mirror images, about the longitudinal center plane 116, of the traction lugs 110 of the right set. Thus, only one traction lug 110 will be described in detail herewith. Specifically, to simplify directional reference, the traction lug 110 that will be described is one of the tractions lugs 110 of the left set of traction lugs.

The traction lug 110, which extends in the lateral and longitudinal directions, has a generally arcuate shape. The shape of the traction lug 110 will be described in greater detail below. It is contemplated that in some implementations of the present technology, the traction lug 110 could be linear. The traction lug 110 has an inner portion. 150 and an outer portion 152, both of which extend along a length of the traction lug 110, and where the inner portion 150 is closer to the longitudinal center plane 116 than the outer portion 152.

The inner portion 150 has an innermost section 160 and an intermediate section 162. The intermediate section 162 is disposed laterally outwardly from the innermost section 160 (i.e., between the outer portion 152 and the innermost section 160).

The traction lug 110 is positioned such that the innermost section 160 is laterally spaced from the longitudinal center plane 116. It is contemplated that in other embodiments, the innermost section 160 could be at least partially aligned with the longitudinal center plane 116. The innermost section 160, which extends laterally and longitudinally until the intermediate section 162, defines a notch 164. The notch 164 can vary from one embodiment of the endless track 100 to another. The notch 164 is laterally offset from the wheel engaging section 120a (depicted in dotted lines in FIG. 5) of the endless track 100. In some instances, the configuration of the notch 164 can depend on the load that is to be sustained by the endless track 100 (e.g., weight of vehicle to which the track system 50 is connected). In some instances, the notch 164 can assist in balancing pressure along the outer tread 130.

Still referring to FIGS. 3 and 5, the intermediate section 162 is generally aligned with the wheel engaging section 120a, which is depicted in dotted lines in FIG. 5, (i.e., the intermediate section 162 extends laterally and longitudinally across a width of the wheel engaging section 120a). Thus, an intersection between the innermost and intermediate sections 160, 162 generally coincides with an inner lateral border of the wheel engaging section 120a. It is contemplated that in some embodiments, the intersection between the innermost and intermediate sections 160, 162 could be offset from an inner edge of a corresponding one of the wheel engaging sections 120a, 120b. It is to be noted that the intersection is merely an imaginary border to aid in understanding relative positioning of the innermost and intermediate sections 160, 162.

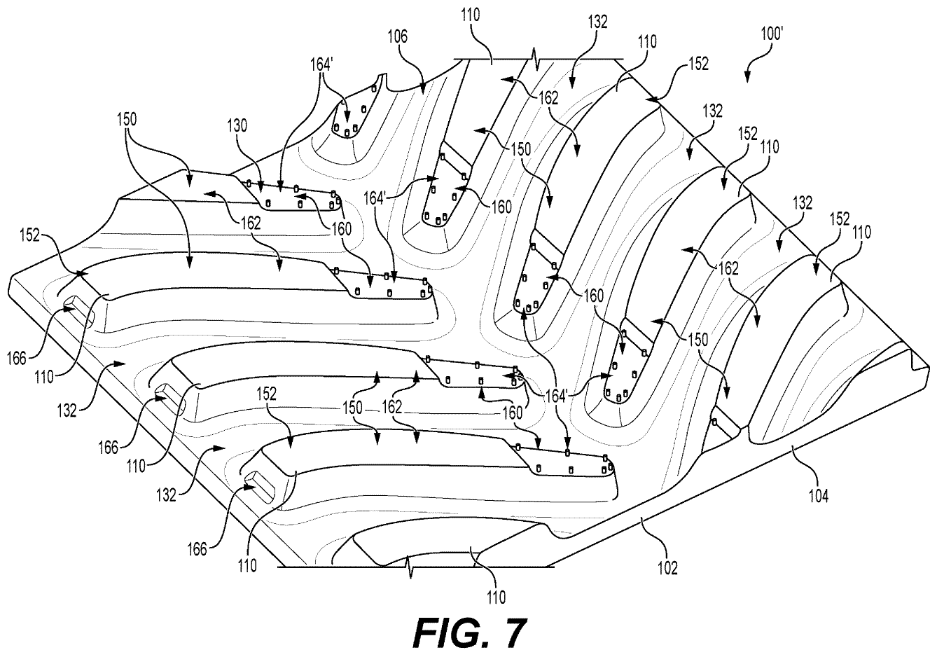

The outer portion 152 extends laterally outwardly and longitudinally from the inner portion 150. Specifically, the outer portion 152 extends laterally outwardly from the intermediate section 162. The outer portion 152 is laterally offset from the wheel engaging section 120a, and is generally aligned with the external section 122a (depicted in dotted lines in FIG. 5). In the illustrated embodiment, the outer portion 152 extends until the lateral track body edge 118a. In other embodiments, the outer portion 152 could be spaced from the lateral track body edge 118a. The outer portion 152 also defines a chamfer 166 (best seen in FIG. 7). In some embodiments, the chamfer 166 could be omitted.

As mentioned above, the traction lug 110 is arcuate. In the illustrated embodiment, the traction lug 110 generally extends along a line 155 (shown in FIG. 5). As one may see, the line 155 is arcuate, such that the inner portion 150 extends in a given orientation whereas the outer portion 152 extends in another orientation. The configuration of the traction lug 110 is such that the outer portion 152 is generally perpendicular to a longitudinal plane of the track body 102 (e.g., the outer portion 152 is generally perpendicular to the track body lateral edge 118a). It is contemplated that in other embodiments, another portion of the traction lug 110 could be generally perpendicular to a longitudinal plane of the track body 102. This generally perpendicular configuration can assist in enhancing traction.

The inner portion 150 has an inner volume, the outer portion 152 has an outer volume. As will be described in greater detail below, while the overall volume of the traction lug 110 is kept similar to the volume of a conventional traction lug, the distribution of volume is configured to reduce heat generation within the endless track 100 when the endless track 100 is used on uneven surfaces.

Referring to FIGS. 3, 5, 6A and 6B, the endless track 100 is configured to increase the volume of material at the intermediate section 162 (which extends below the wheel engaging section 120a) and decrease the outer volume by having the traction lug 110 be tapered. In more detail, the cross-sectional area of the traction lug 110 varies along the line 155. The cross-sectional area of the traction lug 110 in the innermost section 160 increases in the laterally outward direction along the line 155. The cross-sectional area of the traction lug 110 in the intermediate section 162 decreases in the laterally outward direction along the line 155. The cross-sectional area of the outer portion 152 further decreases in the laterally outward direction along the line 155. It is contemplated that in some embodiments, the cross-sectional area of the traction lug 110 could vary differently, so long as the outer volume is reduced relative to the volume at the intermediate section 162. In some instances, the reduction of the outer volume results in an increase of the inner volume. In other instances, the reduction of the outer volume does not result in an overall increase of the inner volume, due to the presence of the notch 164.

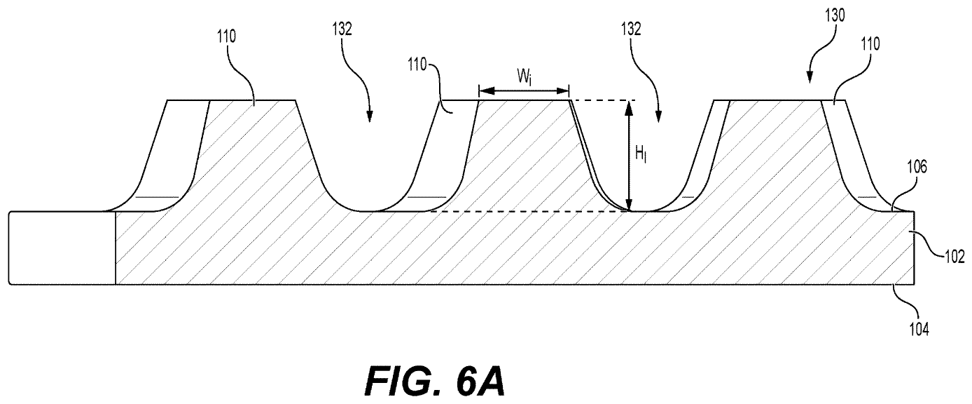

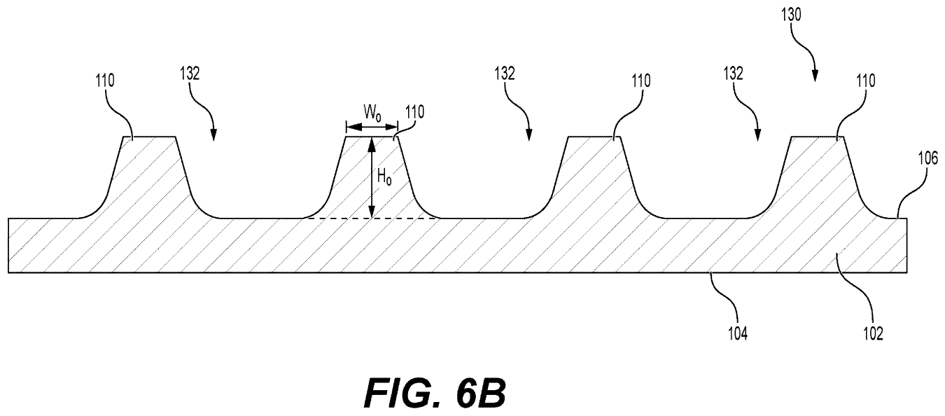

In more detail, with reference to FIG. 6A, an intermediate section cross-section taken across a plane perpendicular to the line 155 has an intermediate height Hi and an intermediate width Wi, and thus an intermediate cross-sectional area. It is to be noted that due to the arcuate profile of the line 155, the cross-sectional plane that is perpendicular to the line 155 of one traction lug 110 is not perpendicular to the line 155 of another traction lug (see for example orientation of cross-sectional lines 6A-6A and 6B-6B in FIG. 5). Thus, only the dimensions Hi and Wi identified in FIG. 6A correspond to the dimensions of the intermediate section cross-section, since the cross-sectional plane is perpendicular to that given traction lug 110. It is to be noted that the intermediate width Wi varies along a height of the traction lug 110. For the purposes of the present description, the intermediate width Wi corresponds to a width at a topmost point of the traction lug 110. It is understood that the intermediate width Wi could correspond to a width taken at another vertical point of the traction lug 110 without departing from the scope of the present technology.

Furthermore, with reference to FIG. 6B, an outer portion cross-section taken across a plane perpendicular to the line 155 has an outer height Ho and an outer width Ho, and thus an outer cross-sectional area. For the same reasons mentioned above, only the dimensions Ho and Wo identified in FIG. 6B correspond to the dimensions of the outer portion cross-section, since the cross-sectional plane is perpendicular to that given traction lug 110. It is to be noted that the outer width Wo varies along a height of the traction lug 110. For the purposes of the present description, the outer width Wo corresponds to a width at a topmost point of the traction lug 110. It is understood that the outer width Wo could correspond to a width taken at another vertical point of the traction lug 110 without departing from the scope of the present technology.

In the illustrated embodiment, the intermediate width Wi is greater than the outer width Wo, whereas the intermediate height Hi is generally equal to the outer Ho, such that the intermediate cross-sectional area is greater than the outer cross-sectional area. It is contemplated that in some embodiments, the intermediate width Wi could be generally equal to the outer width Wo, whereas the intermediate height Hi could be greater than the outer height Ho. In other embodiments, the intermediate width and height Wi, Hi could both be greater than, respectively, the outer width and height Wo, Ho. Any such variation is contemplated.

As mentioned above, the endless track 100 also defines a plurality of recesses 132 on the outer surface 106. Each recess 132 is in part defined by two adjacent traction lugs 110 More specifically, a front of the recess 132 is defined by a rear of a first traction lug 110, and a rear of the recess 132 is defined by a front of a second traction lug 110 that is adjacent to the first traction lug 110. The lateral sides of each recess 132 are generally aligned with corresponding lateral sides of the first and second traction lugs 110. It is contemplated that the recesses 132 could be referred to as spaces, gaps and/or voids. Since the recesses 132 are partially defined by the traction lugs 110, and the traction lugs 110 are arcuate as well as tapered, the recesses 132 define a funnel shape (the recesses 132 increase in size in the laterally outward direction). The recesses 132 having a funnel shape can assist in evacuating debris such as mud by guiding said debris toward the lateral track body edges 118a, 118b.

Referring back to FIG. 5, the outer tread 130 has a ground surface ratio, which corresponds to, for a given area of the outer surface 106, a ratio of a traction lug contact area over the given area of the outer surface 106. The outer tread 130 also has, for the given area of the outer surface 106, a ratio of the traction lug contact area over a recess area. In more detail, each of the traction lug 110 has a contact area, which generally corresponds to an outer surface of the traction lug 110. Additionally, each of the recesses 132 has a recess area. In some embodiments, the tread could be configured to increase the recess area and decrease the contact area. For a given area of the outer surface 106, a ratio of the traction lug contact area over the recessed area is between 0.5 to about 0.7. In some embodiments, the ratio of the traction lug contact area over the recessed area can be between about 0.6 and about 0.65. In some embodiments, the ratio of the traction lug contact area over the recessed area can be between about 0.646.

With reference FIG. 7, there is provided an alternative embodiment of the present technology, namely endless track 100′, Features of the endless track 100′ similar to those of the endless track 100 have been labeled with the same reference numerals and will not be described in detail herewith.

The endless track 100′ notably differs from the endless track 100 in that the innermost section 162 defines a recess 164′ instead of a notch 164. Similar to the notch 164, however, the recess 164′ can assist in reducing material required to manufacture the endless track 100. In some instances, the recesses 164′ can be described as a vertical notch 164′.

The endless track 100′ also differs from the endless track 100 in that the outer portions 152 of the traction lugs 110 do not extend all the way to the lateral track body edges 118a, 118b. Thus, the outer portions 152 of the traction lugs 110 are spaced from the lateral track body edges 118a. 118b.

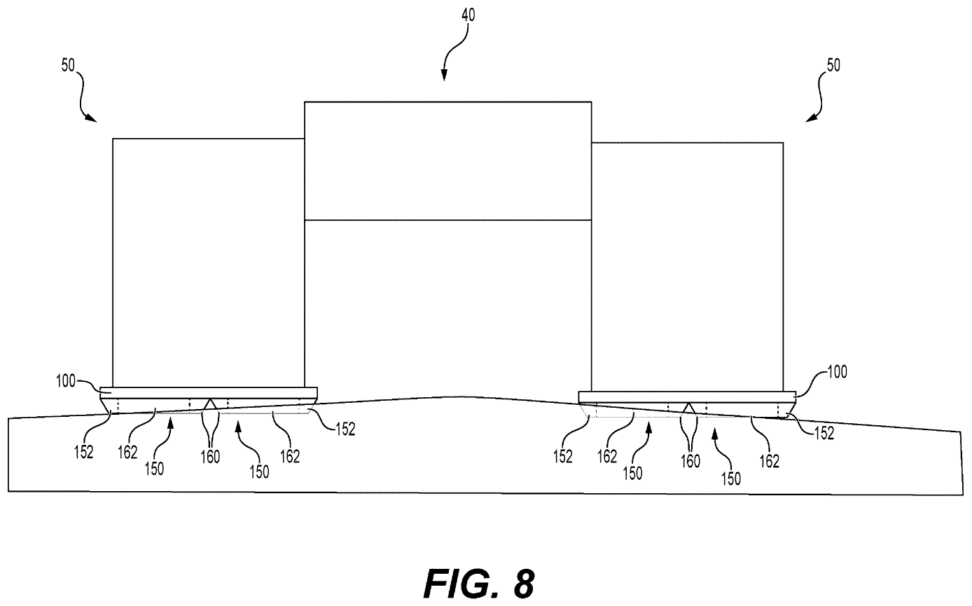

Referring to FIG. 8, and reference back to the endless track 100, the endless track 100 in operation on a crowned road surface will now be described in greater detail.

As shown in FIG. 8, the harvester 40 is travelling on a crowned road. The harvester 40 can be driven by the engagement of the drive wheel assemblies 60 and the track engagers 108 of the left and right track systems 50.

While travelling on a crowned road surface, since the track system 50 is not configured to adapt to the crowned road (i.e., the left and right track systems 50, as mentioned above, are not configured to pivot to compensate for the slope of the crowned road), the endless tracks 100 of the left and right track systems are subjected to high stresses. More specifically, the laterally inner edges of the endless tracks 100 are subjected to high stresses, because, in some instances, the load borne by the endless tracks 100 is spread over a smaller area than if the endless track 100 were to be on a flat road surface (e.g., laterally outer edges of the endless tracks 100 do not contact the road due to the crowned shape thereof). As a result of the higher stresses, high heat is generated. High stresses and high heat generation can both cause premature wear of the endless tracks 100.

To adapt to the slope of the crowed road, the traction lugs 110 are configured to reduce the outer volume thereof, thereby reducing the volume of rubber that is being exposed to high deformation and high stresses and reducing the generation of heat at the outer portions 152 of the traction lugs 110. It is to be noted that the decrease in outer volume can also lead to an enhanced transfer of heat (e.g., via convection). The increase in the rate of heat transfer rate can result in reducing the maximum temperature that is reached by the endless track 100 at the outer portions 152.

Furthermore, because the inner volume of the traction lugs 110, particularly in the intermediate sections 162 is increased, the endless track 100 still has good traction. The increased volume of rubber in the intermediate sections 162, which, as mentioned above, extends below the wheel engaging sections 120a, 120b, can assist in supporting loads transferred to the endless track 100 via the idler and support wheel assemblies 80, 82, 84a, 84b. Additionally, since the innermost sections 160 are offset from the wheel engaging sections 120a, 120b, the presence of the notch 164 (i.e., the reduction of material) alleviates issues caused by the generation of heat.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. An endless track for a track system, the endless track comprising:
a track body having:
an inner surface engageable by at least one wheel assembly of the track system;
an outer surface engageable to a ground surface;
a first wheel engaging section disposed on a first lateral side of the track body; and
a second wheel engaging section disposed on a second lateral side of the track body,
a plurality of track engagers disposed on the inner surface, the track engagers being spaced along a length of the track body;
a plurality of traction lugs projecting from the outer surface, the plurality of traction lugs being spaced along a length of the track body, and a given traction lug of the plurality of traction lugs:
having an inner portion and an outer portion, the inner and outer portions extending along a length of the given traction lug, and the outer portion being closer to an edge of the track body than the inner portion; and
the inner portion having an inner volume, the outer portion having an outer volume, and the outer volume being less than the inner volume, the inner portion includes:
an innermost section laterally offset from a corresponding one of the first wheel engaging section and the second wheel engaging section; and
an intermediate section configured to extend below the corresponding one of the first wheel engaging section and the second wheel engaging section.

2. The endless track of claim 1, wherein for the given traction lug, the inner portion extends in a first orientation, the outer portion extends in a second orientation, and the first orientation is different from the second orientation.

3. The endless track of claim 1, wherein the track body has a longitudinal plane, and the given traction lug is at least substantially perpendicular to the longitudinal plane.

4. The endless track of claim 3, wherein the outer portion of the given traction lug is at least partially perpendicular to the longitudinal plane.

5. The endless track of claim 1, wherein the given traction lug is partially arcuate.

6. The endless track of claim 1, wherein the endless track defines a plurality of recesses on the outer surface, a given recess of the plurality of recesses being in part defined by two adjacent traction lugs of the plurality of traction lugs.

7. The endless track of claim 6, wherein the given recess of the plurality of recesses has a funnel shape.

8. The endless track of claim 6, wherein, for a given section of the endless track:
the plurality of traction lugs defines a traction lug contact area;
the plurality of recesses defines a recessed area; and
a ratio of the traction lug contact area over the recessed area is between 0.5 and 0.7.

9. The endless track of claim 8, wherein the ratio of the traction lug contact area over the recessed area is between 0.6 and 0.7.

10. (canceled)

12. The endless track of claim 1, wherein a given traction lug of the plurality of traction lugs has:
a first cross-sectional area taken across a plane perpendicular to the inner portion; and
a second cross-sectional area taken across a plane perpendicular to the outer portion, wherein
the first cross-sectional area is greater than the second cross-sectional area.

13. The endless track of claim 12, wherein:
the first cross-sectional area has a first width; and
the second cross-sectional area has a second width, wherein
the first width is greater than the second width.

14. The endless track of claim 12 wherein:
the first cross-sectional area has a first height; and
the second cross-sectional area has a second height, wherein
the first height is greater than the second height.

15. The endless track of claim 1, wherein the given traction lug defines a notch at the innermost section.

16. The endless track of claim 1, wherein the plurality of track engagers is generally centered across a width of the track body.

17. The endless track of claim 1, wherein the plurality of track engagers is a plurality of driving lugs.

18. The endless track of claim 1, wherein a shape of the plurality of traction lugs is configured to reduce heat generation on the plurality of traction lugs in response to the endless track being operated on a crowned ground surface.

19. The endless track of claim 1, wherein:
the plurality of traction lugs is a first plurality of traction lugs disposed on the first lateral side of the track body; and
the endless track further includes a second plurality of traction lugs disposed on the second lateral side of the track body.

20. The endless track of claim 19, wherein the outer portion of a traction lug of the first plurality of traction lugs is longitudinally offset from the outer portion of a corresponding traction lug of the second plurality of traction lugs.

21. The endless track of claim 20, wherein:
the outer portion of the traction lugs of the first plurality of traction lugs is laterally offset from the first wheel engaging section; and
the outer portion of the traction lugs of the second plurality of traction lugs is laterally offset from the second wheel engaging section.

22. (canceled)

23. The endless track of claim 1, wherein the track body has:
a first external section disposed laterally outwardly from the first wheel engaging section, the first external section being sloped in a lateral direction, and
a second external section disposed laterally outwardly from the second wheel-engaging section, the second external section being sloped in a lateral direction.
